(19) United States
(12) Patent Application Publication
(10) Pub. No.: US 2014/0045365 A1
(43) Pub. Date: Feb. 13, 2014

(54) ADJUSTABLE BACKSHELL FOR WIRING HARNESS

(71) Applicants: Joseph Nathan Reilly, Wichita, KS (US); Jacqueline Marie Freed, Wichita, KS (US)

(72) Inventors: Joseph Nathan Reilly, Wichita, KS (US); Jacqueline Marie Freed, Wichita, KS (US)

(73) Assignee: Power In Operation, LLC, Wichita, KS (US)

(21) Appl. No.: 13/569,987

(22) Filed: Aug. 8, 2012

(51) Int. Cl. H01R 13/658

(52) U.S. Cl. CPC H01R 13/658
USPC 439/446

(57) ABSTRACT

A backshell includes a cable-receiving portion presenting a front end, a rear end, and a first longitudinal axis; a connector portion presenting a front end, a rear end, and a second longitudinal axis; and a swivel joint operably coupling the front end of the cable-receiving portion with the rear end of said connector portion and operable to permit selective relative movement between the cable-receiving portion and the connector portion such that they may assume different relative positions with the longitudinal axes thereof at correspondingly different angles.

### BACKGROUND

Backshell devices provide a secure connection between a wiring harness and an associated electrical connector. Backshells not only provide strain relief to prevent damage to the termination points of the wiring harness but may also be designed for coupling with and anchoring a braided sheath encasing the wires in the wiring harness to protect the wiring from the effects of electromagnetic interference (EMI).

The particular design of an electrical or electronic system may require that a wiring harness enter a backshell at a particular angle. For example, some systems require a wiring harness to enter a backshell from a straight orientation, a 45° orientation, or a 90° orientation. To accommodate these different requirements, various configurations of backshells are known, including 0°, 45°, and 90° backshells. Unfortunately, the required orientation of wiring harnesses to their backshells is often not known until the devices are installed, so installers must stock and carry all configurations of the backshells.

Adjustable backshells have been developed in an attempt to resolve the above-described problems, but known adjustable backshells are either difficult to use and adjust and/or overly complicated and expensive.

Accordingly, there is a need for an improved adjustable backshell that overcomes the limitations of the prior art.

### SUMMARY

The present invention solves the above-described problems and provides a distinct advance in the art of backshell devices by providing an improved adjustable backshell that can be quickly and easily configured to secure a wiring harness in nearly any orientation.

A backshell constructed in accordance with various embodiments of the invention broadly includes a tubular, open-ended, cable-receiving portion; a tubular, open-ended, connector portion; and a swivel joint interconnecting the cable-receiving portion and connector portion. The cable-receiving portion and connector portion are relatively shiftable my means of the swivel joint so that the cable-receiving portion and connector portion may assume an infinite number of relative positions between a substantially straight and axially aligned position and a 90° position.

An embodiment of the swivel joint may comprise a first circumferentially extending bearing surface carried by a front end of the cable-receiving portion; a second circumferentially extending bearing surface carried by a rear end of the cable connector portion; and structure operable to maintain the first and second bearing surfaces in mating adjacency during relative swiveling movement of the cable-receiving and connector portions.

An embodiment of the structure for maintaining the bearing surfaces together may comprise an annular connection flange carried by the connector portion, and a collar formed in the connector portion and surrounding the connection flange. Mating slots are formed in the annular connection flange and the collar to receive a snap-ring or similar fastener for holding the flange and collar together.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a backshell constructed in accordance with embodiments of the present invention.

FIG. 2 is a side elevational view of the backshell positioned in its straight or aligned orientation.

FIG. 3 is a perspective view of the backshell positioned in its 90° orientation.

FIG. 4 is a vertical sectional view of the backshell positioned in its straight orientation.

FIG. 5 is a vertical sectional view of the backshell positioned in its 90° orientation.

FIG. 6 is a perspective view of the cable-receiving portion of the backshell.

FIG. 7 is a perspective view of the connector portion of the backshell with its locking not removed.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

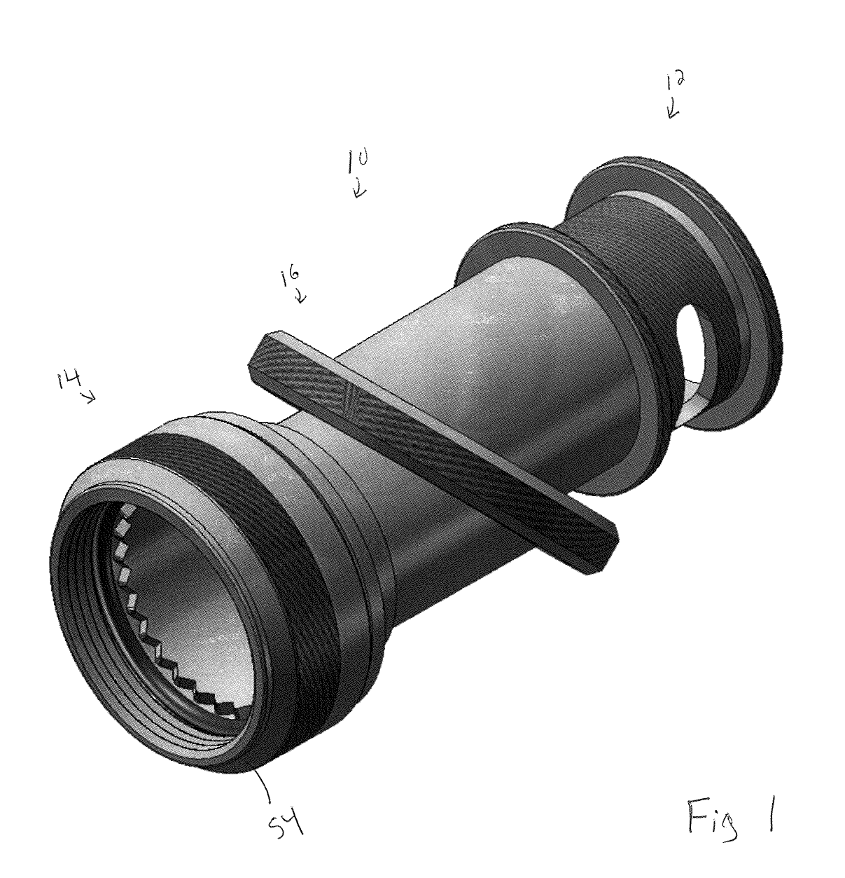

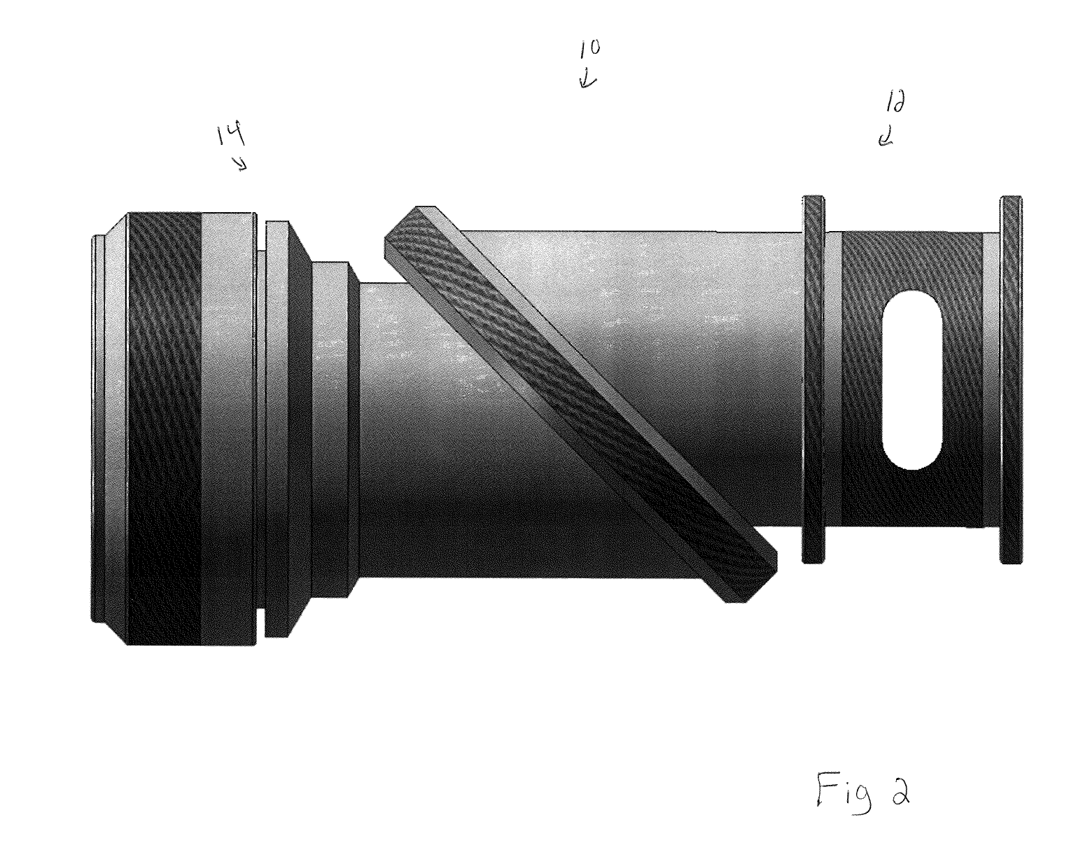

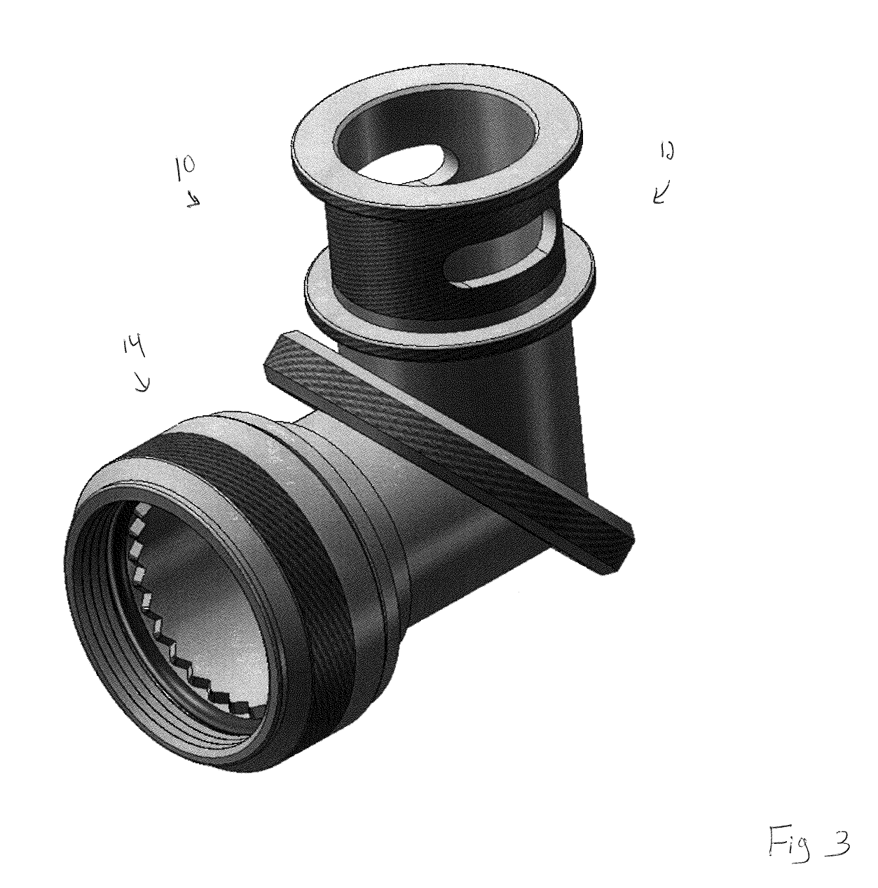

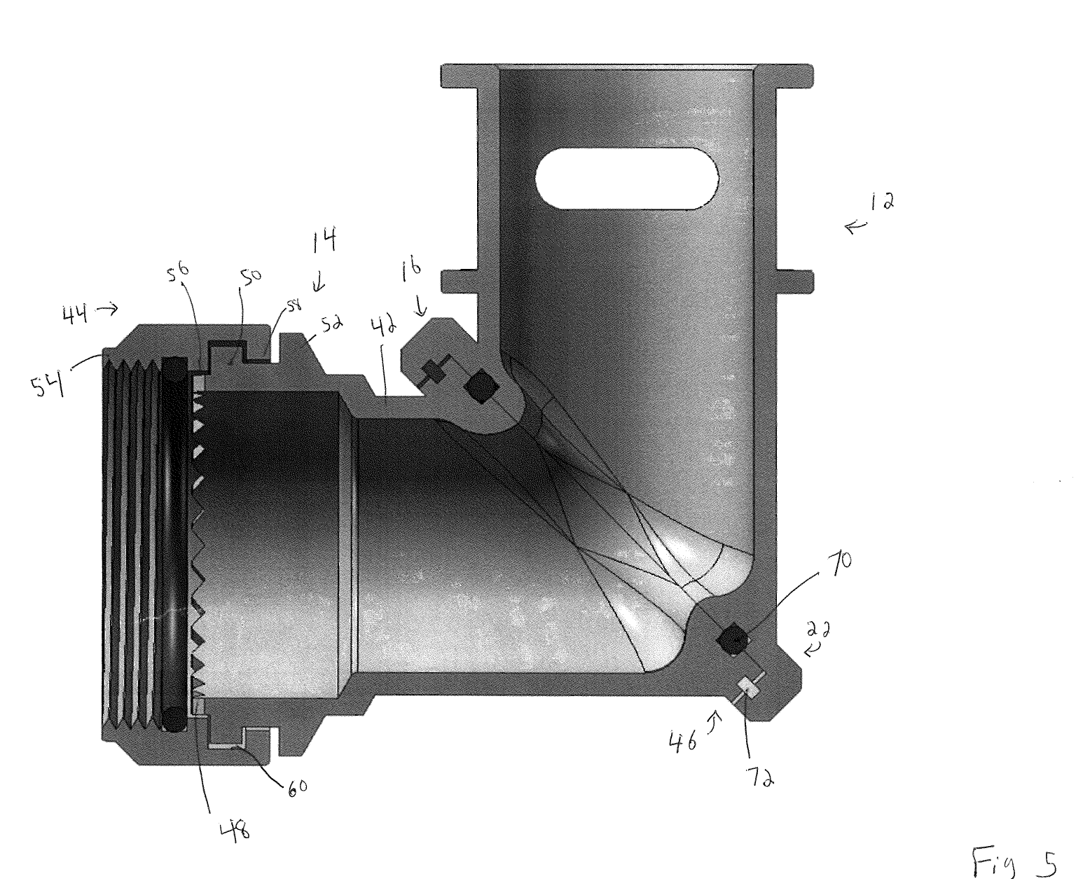

A backshell 10 constructed in accordance with various embodiments of the invention is illustrated in the drawing figures and broadly includes a tubular, open-ended, cable-receiving portion 12; a tubular, open-ended, connector portion 14; and a swivel joint 16 interconnecting the cable-receiving portion 12 and the connector portion 14. The cable-receiving portion 12 and connector portion 14 are relatively shiftable my means of the swivel joint 16 so that the cable-receiving portion 12 and connector portion 14 may assume an infinite number of relative positions between the substantially straight and axially aligned position of FIGS. 1, 2, and 4 and the 90° position of FIGS. 3 and 5.

Embodiments of the backshell 10 may be used with copper wires, fiberoptic cables, or any other conductors. As used herein, the term “wiring harness” includes any number and type of electrical, optical, or other conductors.

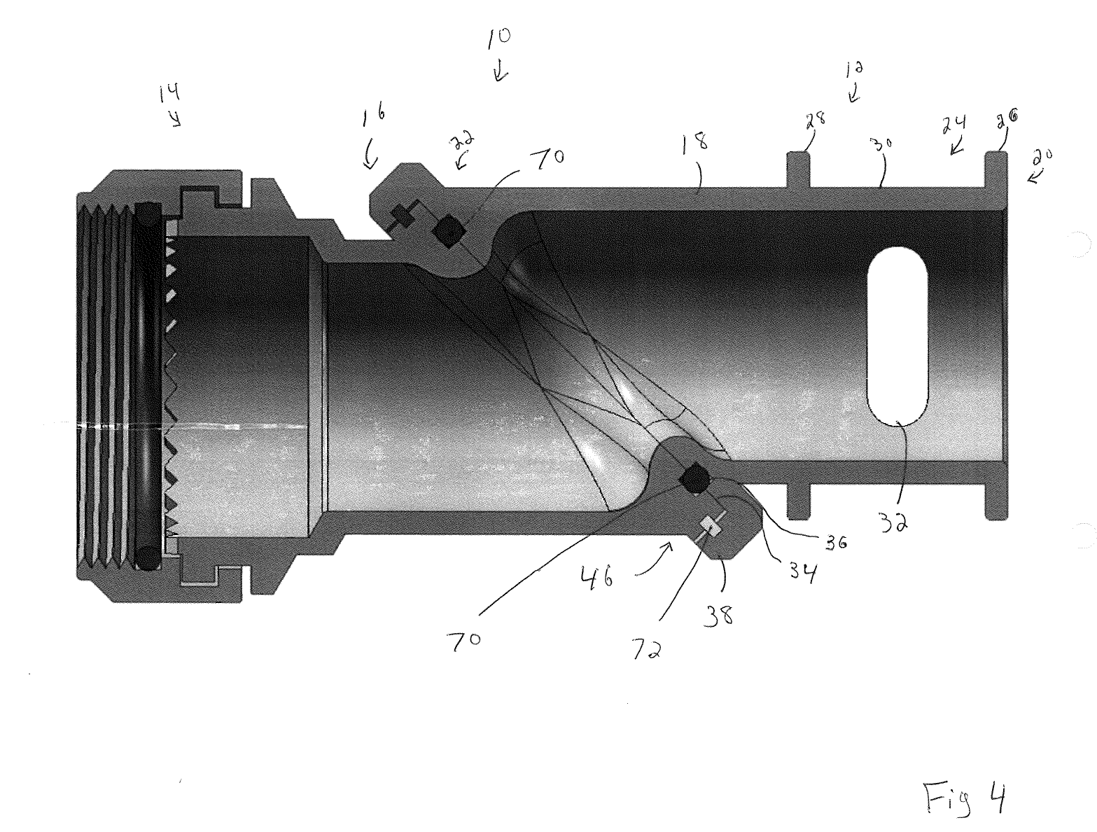

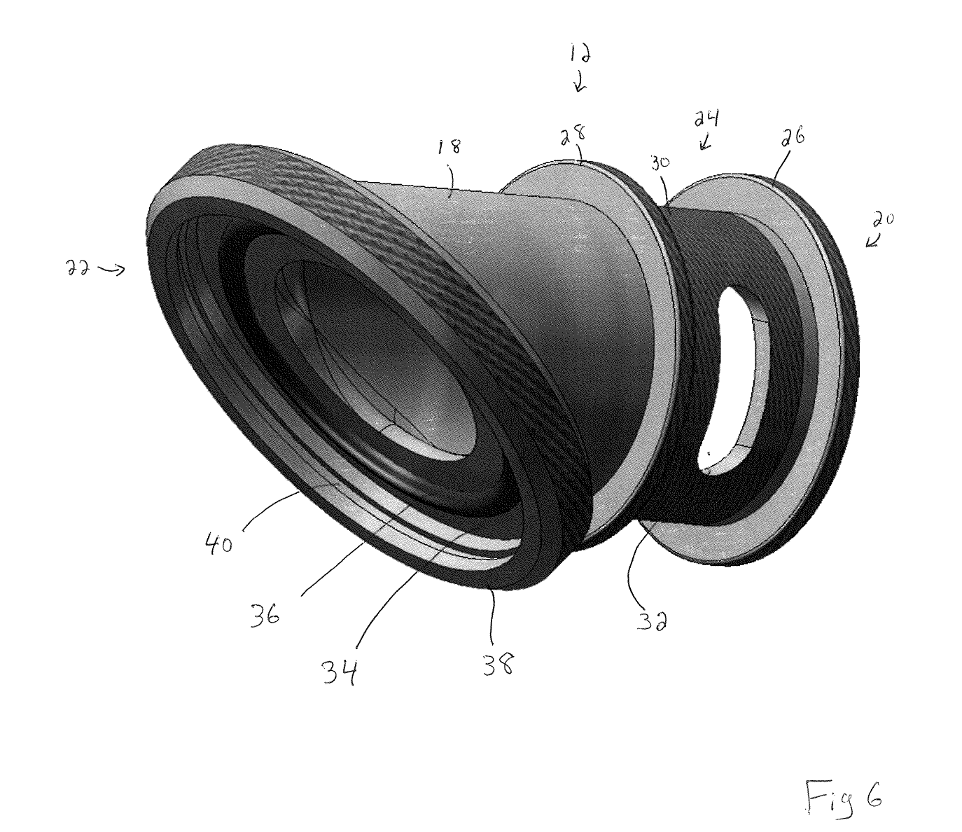

The cable-receiving portion 12 of the backshell 10 is best illustrated in FIGS. 4 and 6 and includes a tubular body 18 having a rear section 20 and a forward joint section 22. The rear section 20 includes a sheath termination nipple 24 that is formed by a pair of spaced-apart radially enlarged flanges 26, 28 that define an annular fastener-receiving channel 30 therebetween. The outermost surfaces of the flanges 26, 28 and the channel 30 may be knurled or otherwise roughened to increase their friction. A sheath of a wiring harness (not shown) as well as the wiring harness's outer jacket may be stretched over the flanges 26, 28 and then compressed and held in the channel 30 by a clamp, clip, spring, or other fastener. A slot 32 is formed in the channel 30 for grounding purposes.

The forward section 22 of the cable-receiving portion 12 includes an obliquely oriented, annular bearing wall 34 provided with a continuous circular groove 36. The forward section also includes a radially outwardly and forwardly extending peripheral collar 38 equipped with an internal slot 40. The outermost surface of the collar 38 may be knurled or otherwise roughened to provide a gripping surface for holding and adjusting the backshell as described below.

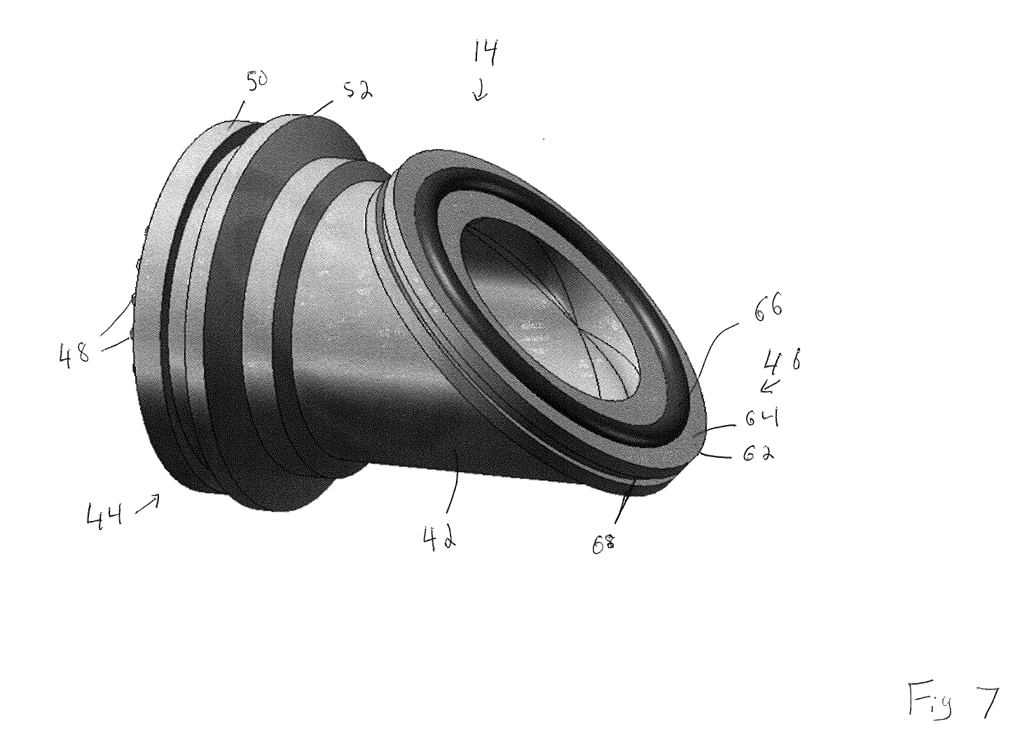

The connector portion 14 of the backshell 10 is best illustrated in FIGS. 1, 5, and 7 and includes a tubular body 42 presenting a forward section 44 and a rear joint section 46. The forward section 44 includes a toothed peripheral edge 48 that serves to locate and hold a connector insert as described below and a pair of laterally spaced apart, radially outwardly extending, annular shoulders 50, 52. A threaded coupling nut 54 is rotatably coupled to the forward section of the connector portion by spaced-apart inwardly extending collars 56, 58. The collars 56, 58 are positioned on opposite sides of the shoulder 50 and together define an annular channel 60 in which the shoulder 50 is received.

The forward section 44 also receives and supports a connector insert (not shown) that is configured to mate with a complemental connector on an electrical or electronic device when the coupling nut 54 is threaded over the complemental connector. The connector insert may be a receptacle-type or “female” insert comprising a plurality of receptacles disposed therein or may be a plug-type or “male” insert with a plurality of outwardly extending pins or plugs. The individual wires in the wiring harness enter the rear section 20 of the cable-receiving portion 12 of the backshell and terminate at the rear of the connector insert in a conventional manner.

The rear joint section 46 of the connector portion 14 includes an annular, obliquely oriented connection flange 62 presenting a bearing wall 64 provided with a continuous groove 66. In addition, the outboard surface of the flange 62 has a continuous peripheral slot 68.

As best shown in FIGS. 4 and 5, the forward joint section 22 of the cable-receiving portion 12 and the rear joint section 46 of the connector portion 14 are joined by the swivel joint 16 to present the overall backplate 10. An O-ring 70 is seated within groove 66, and a metallic snap-ring 72 is inserted into slot 68. The forward joint section 22 of the cable-receiving portion 12 is then pressed onto flange 62 of the connector portion 14 such that the collar 38 surrounds the flange 62, and the snap-ring 72 seats into the slots 40 and 68. In this orientation, the bearing walls 34 and 64 are in close, mating adjacency, with the O-ring 70 captively retained between the grooves 36 and 66, and with the snap-ring 72 within slots 40 and 68 serving to maintain the rotary connection between cable-receiving portion 12 and connector portion 14.

In order to adjust the relative positions of the cable-receiving portion 12 and connector portion 14, an installer may simply grasp the portions and exert a relative turning or twisting movement until they are in the desired angular relationship. Advantageously, no tools are required to adjust the angular orientation of the backshell. It will be appreciated that the cable-receiving portion 12 and connector portion 14 may assume any position between that shown in FIG. 1 where the longitudinal axes of the portions are in essentially parallel, offset relation, to the 90° position of FIG. 3. Once positioned in a desired relative orientation, the cable-receiving portion 12 and connector portion 14 may be locked or otherwise held in place by a suitable locking mechanism.

The components of the backshell 10 may be formed by any suitable materials including synthetic resin materials, metals, and allows and may be of any size to accommodate any type and size of wiring harness.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. An adjustable backshell comprising:
a cable-receiving portion presenting a front section, a rear section, and a first longitudinal axis; a connector portion presenting a front section, a rear section, and a second longitudinal axis; and
a swivel joint operably coupling the front section of the cable-receiving portion with the rear section of the connector portion and operable to permit selective relative movement between the cable-receiving portion and the connector portion such that they may assume different relative positions with the longitudinal axes thereof at correspondingly different angles, the swivel joint comprising—a first bearing surface carried by the front section of the cable-receiving portion; a second bearing surface carried by the rear section of the connector portion; and
structure for maintaining the first and second bearing surfaces in close, face-to-face mating adjacency during relative swiveling movement of the cable-receiving portion and the connector portion.

2. The adjustable backshell of claim 1, the structure for maintaining the first and second bearing surfaces comprising an annular connection flange carried by one of the cable-receiving portion and connector portion and including a wall defining one of the first or second bearing surfaces thereof, and a collar formed in the other of the cable-receiving portion and the connector portion and including a wall defining the other of the first or second bearing surfaces, the collar surrounding the connection flange.

3. The adjustable backshell of claim 1, the cable-receiving portion including a sheath termination nipple for coupling with and terminating a sheath of a wiring harness secured by the backshell.

4. The adjustable backshell of claim 1, the connector portion including a rotatable nut for coupling with an external connector.

5. The adjustable backshell of claim 2, the annular connection flange and the collar including mating slots that receive a snap-ring for holding the annular flange and the collar together.

6. The adjustable backshell of claim 2, the annular connection flange and the collar including mating grooves that receive an O-ring for facilitating the selective relative movement of the cable-receiving portion and the connector portion.

7. The adjustable backshell of claim 1, further comprising a locking mechanism for locking the cable-receiving portion and the connector portion in a desired relative position .

8. An adjustable backshell comprising:
a cable-receiving portion presenting a front section, a rear section, and a first longitudinal axis; a connector portion presenting a front section, a rear section, and a second longitudinal axis; and a swivel joint operably coupling the front section of the cable-receiving portion with the rear section of the connector portion and operable to permit selective relative movement between the cable-receiving portion and the connector portion such that they may assume different relative positions with the longitudinal axes thereof at correspondingly different angles, the swivel joint comprising—a first circumferentially extending bearing surface carried by the front section of the cable-receiving portion and oriented at an oblique angle relative to the first longitudinal axis; a second circumferentially extending bearing surface carried by the rear section of the connector portion and oriented at an oblique angle relative to the second longitudinal axis; and structure for maintaining the first and second bearing surfaces in close, face-to-face, mating adjacency during relative swiveling movement of the cable-receiving portion and the connector portion.

9. The adjustable backshell of claim 8, the structure for maintaining the first and second bearing surfaces comprising an annular connection flange carried by the connector portion and including a wall defining the second bearing surface, and a collar formed in the cable-receiving portion and including a wall defining the first bearing surface, the collar surrounding the connection flange.

10. The adjustable backshell of claim 8, the cable-receiving portion including a sheath termination nipple for coupling with and terminating a sheath of a wiring harness secured by the backshell.

11. The adjustable backshell of claim 8, the connector portion including a rotatable nut for coupling with an external connector.

12. The adjustable backshell of claim 9, the annular connection flange and the collar including mating slots that receive a snap-ring for holding the annular flange and the collar together.

13. The adjustable backshell of claim 9, the annular connection flange and the collar including mating grooves that receive an O-ring for facilitating the selective relative movement of the cable-receiving portion and the connector portion.

14. An adjustable backshell comprising:
a cable-receiving portion presenting a front section, a rear section, and a first longitudinal axis; a connector portion presenting a front section, a rear section, and a second longitudinal axis; and a swivel joint operably coupling the front section of the cable-receiving portion with the rear section of the connector portion and operable to permit selective relative movement between the cable-receiving portion and the connector portion such that they may assume different relative positions with the longitudinal axes thereof at correspondingly different angles, the swivel joint comprising—a first circumferentially extending bearing surface carried by the front section of the cable-receiving portion and oriented at an oblique angle relative to the first longitudinal axis; a second circumferentially extending bearing surface carried by the rear section of the connector portion and oriented at an oblique angle relative to the second longitudinal axis; and an annular connection flange carried by the connector portion and including a wall defining the second bearing surface, and a collar formed in the cable-receiving portion and including a wall defining the first bearing surface, the collar surrounding the connection flange for maintaining the first and second bearing surfaces in close, face-to-face, mating adjacency during relative swiveling movement of the cable-receiving portion and the connector portion.

15. The adjustable backshell of claim 14, the cable-receiving portion including a sheath termination nipple for coupling with and terminating a sheath of a wiring harness secured by the backshell.

16. The adjustable backshell of claim 14, the connector portion including a rotatable nut for coupling with an external connector.

17. The adjustable backshell of claim 14, the annular connection flange and the collar including mating slots that receive a snap-ring for holding the annular flange and the collar together.

18. The adjustable backshell of claim 14, the annular connection flange and the collar including mating grooves that receive an O-ring for facilitating the selective relative movement of the cable-receiving portion and the connector portion.
